(19) United States
(12) Patent Application Publication
(10) Pub. No.: US 2005/0092423 A1
(43) Pub. Date: May 5, 2005

(54) Method of manufacturing a core for molding a tire

(75) Inventor: Alain Soulalioux, Saint-Beauzire (FR)

Correspondence Address: COHEN, PONTANI, LIEBERMAN & PAVANE;Suite 1210, 551 Fifth Avenue, New York, NY, 10176, US

(73) Assignee: Michelin Recherche et Technique S.A., Granges-Paccot (CH)

(21) Appl. No.: 10/926,494

(22) Filed: Aug. 26, 2004

(30) Foreign Application Priority Data
Sep. 5, 2003 (FR) 03/10571

(51) Int. Cl. B29C 35/00

(52) U.S. Cl. 156/110.1; 264/310; 425/435

(57) ABSTRACT

A method of manufacturing a core for molding a tire, wherein the core (1) comprises an annular membrane (4). The membrane is placed in a rotomolding form (2), and a fusible material (6) is introduced into the interior of the membrane. The melting point of the fusible material is between 80° and 250° C. and is introduced in the liquid state. A hollow core, obtained by rotomolding, essentially consists of a crust (7) of the fusible material in its solid state.

### FIELD OF THE INVENTION

The present invention relates to the manufacture of tires. More specifically, it relates to the methods in which use is made of a core on which an uncured tire is built, the assembly then being placed in a curing mold.

### BACKGROUND OF THE INVENTION

One particular feature of this type of method is the final step where the core is removed from the tire (also referred to as “core removal”). This is because the core (around which the tire is built and then molded) has to be able to be removed from the molded tire at the end of curing without damaging or permanently deforming this tire.

To do this, it is known for example to use a rigid core made up of several elements which can move (radially) with respect to one another. It is then possible to remove said elements, one by one, from the molded tire. This technique is limited by the fact that said elements must have dimensions such that they can be removed radially from the toroidal cavity of the cured tire. In practice, such a technique can be used satisfactorily only for tires having a limited sidewall height with respect to the internal diameter. For example, a tire of dimensions 225/45/17 can be much more easily separated from such a core than a tire of dimensions 225/75/15.

Also, if the vulcanization is made with a rigid core constituting a part of the mold containing the tire, the vulcanization pressure can not be controlled independently of the temperature.

It is also known to make cores from solid particles (for example sand or glass beads) which are handled like fluids, are held in shape by applying vacuum and can be removed after curing for example by pumping. This technique also has its limitations since it requires a circulation of the solid particles. This technique in particular causes problems of rubbing and wear of the tools and is also not entirely satisfactory with regard to the heat exchanges during curing.

### SUMMARY OF THE INVENTION

One object of the invention is to overcome at least some of the abovementioned drawbacks so as to improve the ability of a core to mold tires of high quality, in particular of a quality which remains constant after many molding cycles, and also in order to simplify the overall process and in particular reduce the size of the industrial plant.

This and other objects are attained in accordance with one aspect of the invention directed to a method of manufacturing a core for molding a tire. The core comprises an annular membrane. The membrane is placed in a rotomolding form. A fusible material is introduced into the interior of the membrane, the melting point of which is between 80° and 250° C., such material being introduced in the liquid state. The core is rotomolded so as to obtain a hollow core that essentially consists of a crust of the material in its solid state.

Preferably, the fusible material is a metal or a metal alloy or a wax having a melting point of between 100 and 160° C.

Also preferably, the method of the invention moreover comprises a step of applying a negative pressure inside the membrane once the crust has been formed.

The invention also relates to a method of manufacturing a tire, comprising such a method of manufacturing a core. Thus, each tire manufacturing cycle includes or is preceded by a core manufacturing cycle.

Preferably, the method of manufacturing a tire according to the invention moreover comprises a step in which said core is filled with a heat transfer fluid, the temperature of which is above said melting point of said fusible material. Also preferably, the pressure of the heat transfer fluid is controlled so as to increase the volume of the core during final molding of the tire.

The method of manufacturing a tire according to the invention may moreover comprise a step of at least partially emptying the membrane and a step of then removing the core from the molded tire.

Preferably, the heat transfer fluid is essentially the same fusible material as that which forms the crust of the core.

The invention also relates to a tire obtained by the method according to the invention.

The invention also relates to a device for manufacturing tires using the method of the invention, comprising a rim, said rim bearing a flexible membrane, said device comprising rotomolding means which make it possible to form a crust below said membrane.

### BRIEF DESCRIPTION OF THE DRAWINGS

FIG. 1 is a view in radial section of part of the core according to the invention before it is rotomolded.

FIG. 2 is a view in radial section of the core at the end of the rotomolding step.

FIG. 3 is a view in radial section of the core on which the uncured tire has been assembled.

FIG. 4 is a view in radial section of the tire molding step.

FIG. 5 is a view in radial section of the step preceding removal of the core from the molded tire.

### DETAILED DESCRIPTION OF THE DRAWINGS

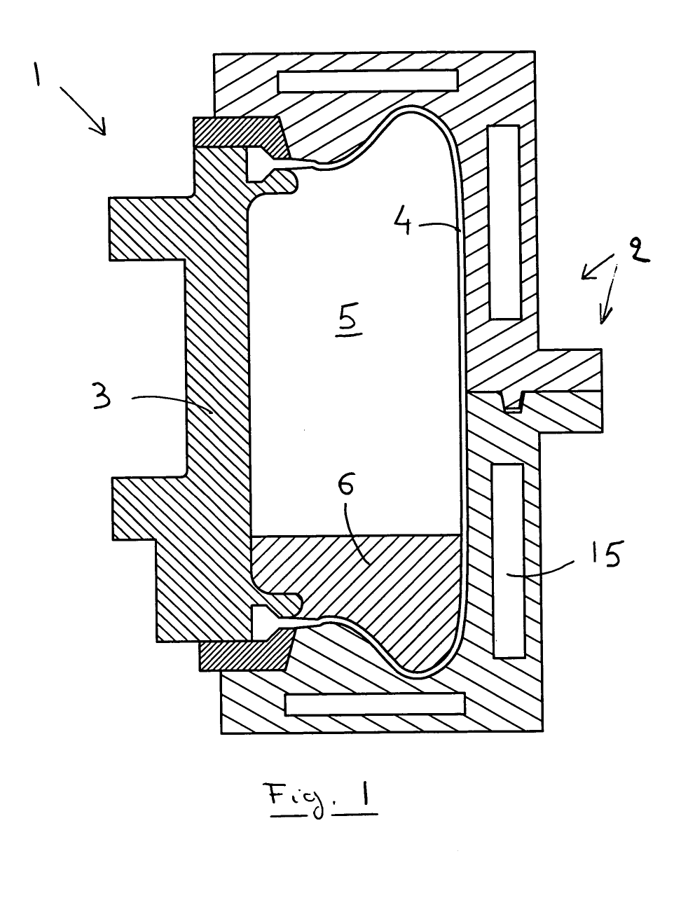

FIG. 1 shows, in section, a core 1 placed in a rotomolding form 2. The core 1 comprises a rim 3 and a deformable membrane 4. The form 2 is closed here, that is to say it is ready for the step of rotomolding the core. The membrane 4 mates with the profile of the form 2 under the effect for example of an overpressure within its internal volume 5 with respect to the external atmosphere. In this figure, the annular volume 5 defined between the membrane 4 and the rim 3 is partially filled with a fusible material 6 in the liquid state. The core is shown arbitrarily in a position in which its axis is vertical so as to show the various elements and in particular the fusible material 6 in its liquid state. Channels 15 may make it possible to control the temperature of the form 2. The means for supplying the fusible material 6 and the means for controlling the internal pressure of the core 1 are not shown.

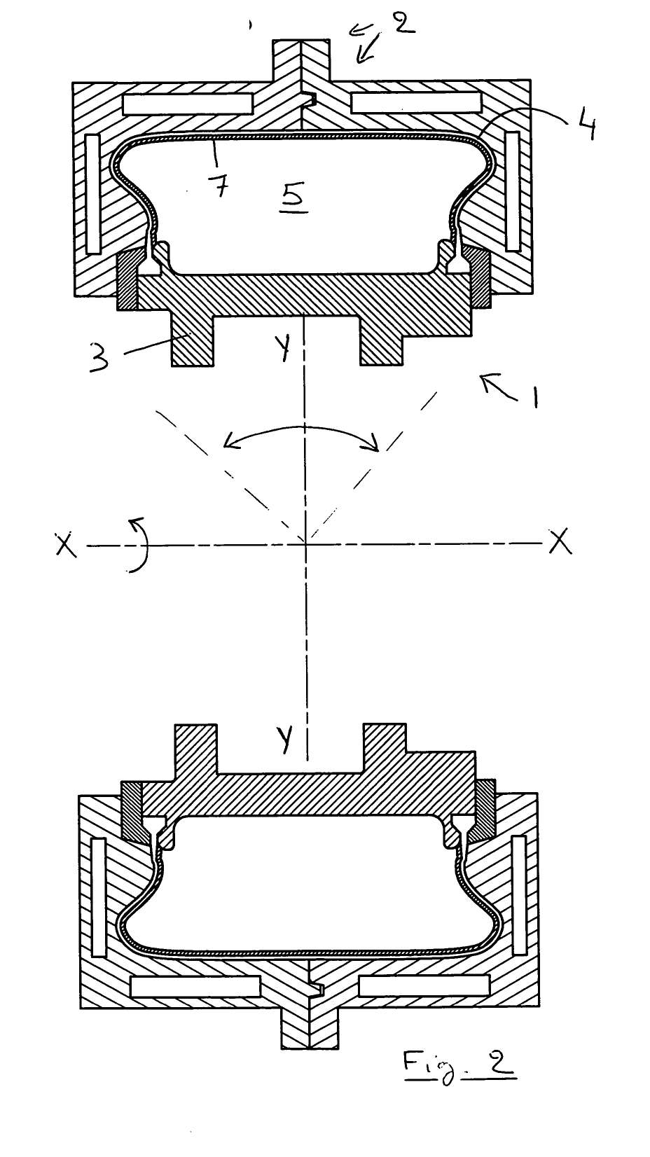

The rotomolding operation may be carried out in a conventional manner, that is to say by combining, in a manner known per se, a movement of rotation of the assembly consisting of the core 1 and the form 2 about its axis XX and oscillations of the plane YY of the core on either side of a vertical plane (cf. FIG. 2). The rotomolding makes it possible to distribute a certain thickness of the fusible material 6, which forms a crust 7 of solidified material when it cools. The person skilled in the art of rotomolding knows how to obtain satisfactory molding by adapting the various parameters of the process in particular as a function of the quantity and characteristics of the fusible material used and the temperature of the elements of the core and of the form 2. By way of example, oscillations of the plane YY of about 45° on either side of the vertical plane have made it possible to obtain a satisfactory thickness distribution.

The rotomolding means are not shown in full here. Only the rotomolding form 2 is shown; the means (known per se) which allow a rotation about two different axes have been omitted.

Once the rotomolding operation is complete and the fusible material 6 has sufficiently cooled and is therefore sufficiently rigid, the form 2 is opened and the core 1 is removed. A rigid core is thus obtained on which an uncured tire (that is to say a tire which is ready to be cured) can be assembled or built. As an alternative to rotomolding, which is an essential feature of the invention, other ways of obtaining a hollow core could be envisaged, such as for example by spraying or by casting and then partial emptying of a suitable fusible material.

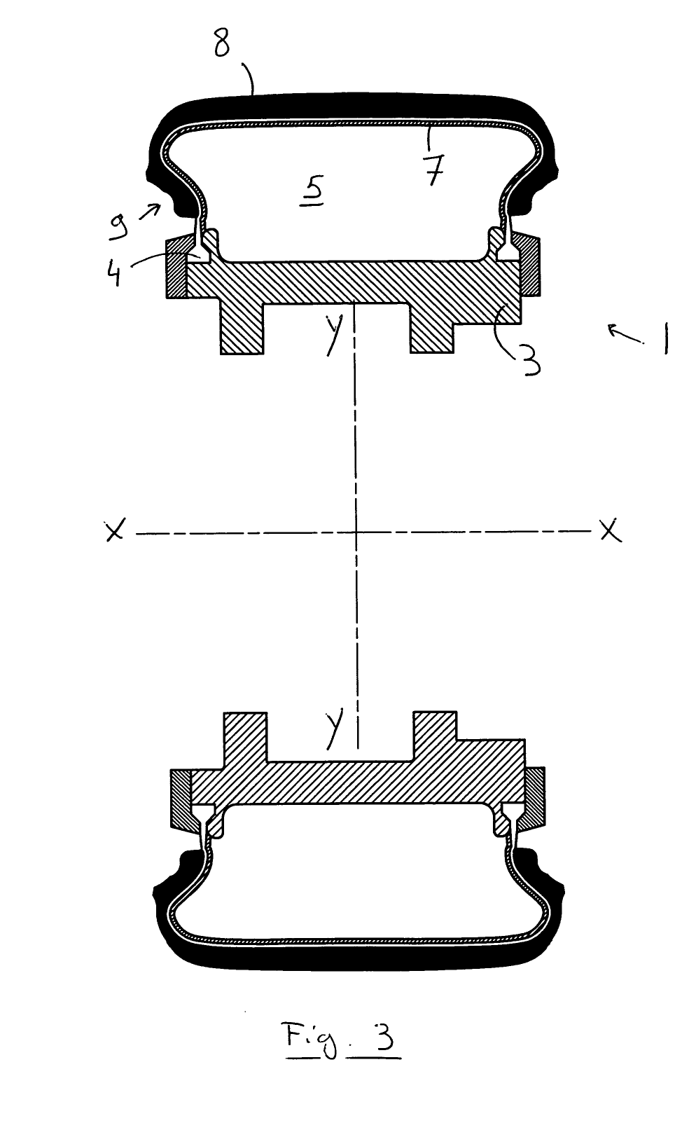

FIG. 3 shows an uncured tire 8 assembled on the core 1 according to the invention. Preferably, the internal volume 5 is subjected to a negative pressure at least for the duration of assembly, so as to keep the membrane 4 pressed against the crust 7. This is particularly useful in the concave areas of the profile such as the lower zone 9 of the tire. Building may be carried out in many different ways, for example by successively depositing and/or winding the constituents of the uncured tire onto the core 1 in a manner known per se.

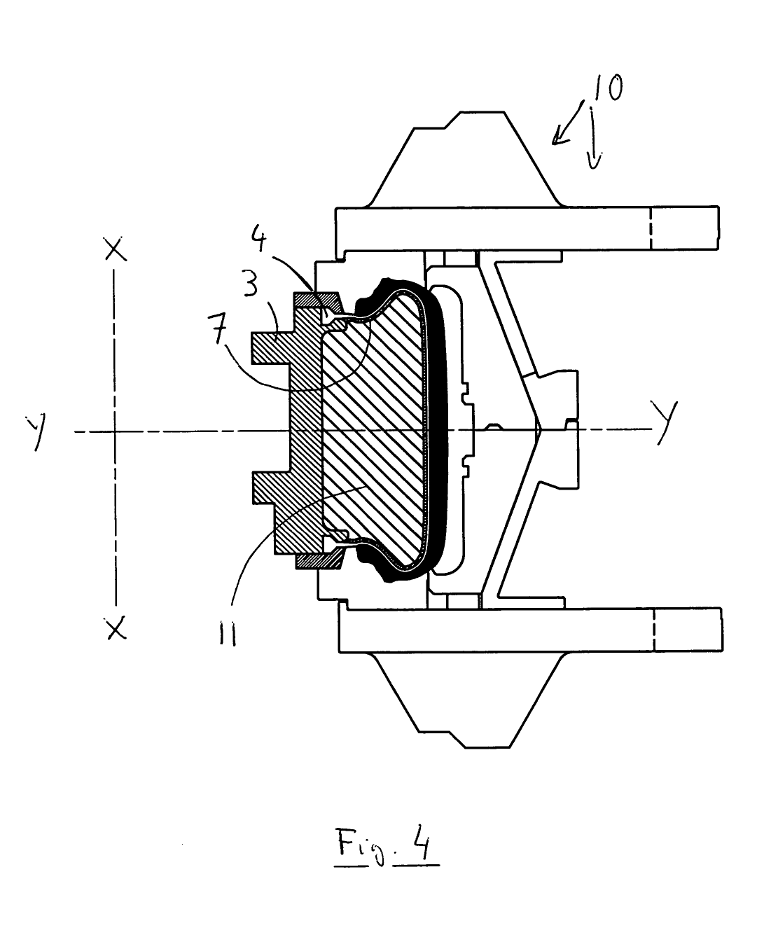

Once the uncured tire 8 is ready to be molded, the core+uncured tire assembly is placed in a curing mold 10 (cf. FIG. 4). Preferably, a heat transfer fluid 11 will then fill the internal cavity of the core so as on the one hand to provide thermal energy that is needed for the curing of the tire and on the other hand to melt the crust (7) of solidified fusible material.

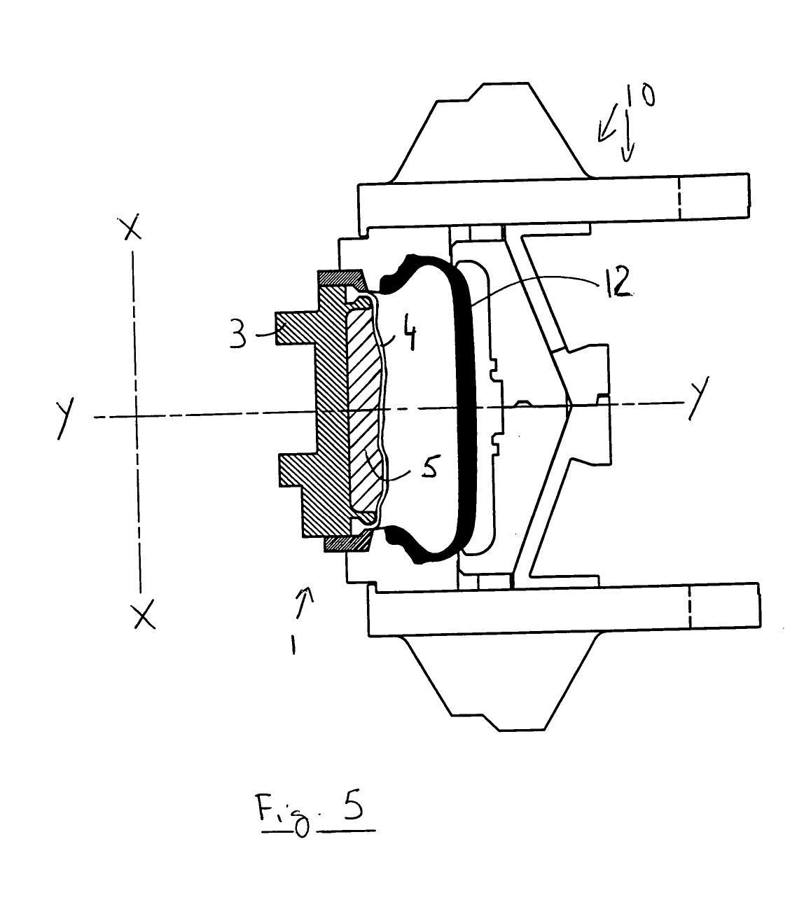

Thus, once the molding operation is complete, the internal volume 5 can be emptied of all or part of the fusible material and heat transfer fluid that it contains, so as to sufficiently reduce the size of the core in order to be able to remove it from the molded tire 12. This is the step shown in FIG. 5, in which the membrane 4 is flexible and deflated for the purpose of removing the core. The core 1 as shown in FIG. 5 may, once it has been removed, undergo a new rotomolding cycle and be involved in the manufacture of a new tire. It is advantageously possible to use several molding cores on each tire manufacturing line.

The heat transfer fluid 11 may be for example an oil or steam that is brought to a suitable temperature as a function of the amount of energy absorbed by the curing of the tire, the quantity of fusible material 6 and the characteristics of the fusible material 6 (in particular its melting point, latent heat of fusion and specific heat). The heat transfer fluid 11 may moreover circulate in a loop between the internal volume 5 of the core and heating means so as to progressively supply the necessary thermal energy to the tire molding cycle.

When the core is emptied, the heat transfer fluid 11 takes with it all or some of the fusible material 6 which is then in its liquid state. It is then possible, for example by means of gravity, to separate the heat transfer fluid from the fusible material in order to prepare for the next manufacturing cycle. An advantage of using an oil or any other material which remains in the fluid state at ambient temperature is that it allows it to be easily handled without any particular constraints, in particular with regard to connections. Water steam may also be an interesting heat transfer fluid 11.

According to one interesting variant of the invention, the heat transfer fluid 11 may also consist of the same material as the fusible material 6. According to this alternative, it is then no longer necessary to provide a system for separating the fluid and the fusible material.

Preferably, the fusible material 6 is a metal or a metal alloy having a low melting point, for example of between 100 and 160° C., for example an alloy containing, in suitable proportions, one or more of the following metals: bismuth, tin, lead, zinc, cadmium.

Moreover, the fusible material 6 may include particles, pieces or marbles of a different additional material, the melting point of which is higher in order to remain solid throughout the core cycle. The benefit of such an inclusion is that it reduces the amount of energy required to make the fusible material 6 liquid. This is because although the additional pieces or particles remain solid, the melting of the fusible material 6 makes it possible to carry out the method of the invention. Preferably, said additional material has a density close to that of the fusible material 6 so that the mixture is as homogeneous as possible.

It will be understood that according to the invention the hollow, rigid core (consisting of the fusible material in its solid form) for assembling the tire may become, when it is filled with the heat transfer fluid at a suitable temperature, a core that is essentially full and flexible with all the advantages that this brings with it in terms of molding and removal from the mold.

By virtue of the invention, it is possible to vary the internal pressure and the volume of the core during molding so as for example to perfect the molding of the details of the tread and/or so as to place the reinforcing structure of the tire under tension (in particular the textile or metal reinforcements of the carcass and crown of the tire).

Preferably, during filling of the core, a negative pressure is maintained below the membrane 4 so that the filling with heat transfer fluid 11 is sufficient and so that the entire crust is thus melted or is at least weakened enough to yield and then be integrated in the liquid mass.

Preferably, the characteristics, temperature and flow rate of the heat transfer fluid are selected such that the filling of the core is complete or virtually complete before the crust yields, in particular under the effect of the negative pressure below the membrane 4.

In the present application, when the adjectives “liquid” or “fluid” are used to describe the physical state of the fusible material 6, this means a state that is sufficiently fluid to allow for example the material to flow or to be pumped. In practice, the material may thus be qualified as liquid even if small solid parts remain therein.

Alternatively, it is possible to use the method of manufacturing a core according to the invention in processes for molding tires using injection molding or transfer molding.

In general, the term “tire” used in the present specification obviously covers any type of elastic tire, pneumatic or otherwise, the invention essentially relating to the molding of this “tire” and not to the functioning thereof.

1. Method of manufacturing a core for molding a tire, said core comprising an annular membrane, said method comprising the following steps:
placing the membrane in a rotomolding form,
introducing into the interior of said membrane a fusible material, the melting point of which is between 80 and 250° C., said material being introduced in the liquid state, and
rotomolding the core so as to obtain a hollow core that essentially consists of a crust of said material in its solid state.

2. Method according to claim 1, in which said fusible material is a metal or a metal alloy having a melting point of between 100 and 160° C.

3. Method according to claim 1, moreover comprising a step consisting in applying a negative pressure inside the membrane once said crust has been formed.

4. Method of manufacturing a tire, comprising the method of manufacturing a core according to claim 1.

5. Method of manufacturing a tire according to claim 4, further comprising a step in which said core is filled with a heat transfer fluid, the temperature of which is above said melting point of said fusible material.

6. Method of manufacturing a tire according to claim 5, in which the pressure of the heat transfer fluid is controlled so as to increase the volume of the core during final molding of the tire.

7. Method of manufacturing a tire according to claim 4, further comprising at least partially emptying the membrane and a step consisting in then removing the core from the molded tire.

8. Method of manufacturing a tire according to claim 4, in which the heat transfer fluid is essentially the same fusible material as that which forms the crust of the core.

9. Device for manufacturing tires, said device comprising a rim, said rim bearing a flexible membrane, said device comprising rotomolding means which make it possible to distribute a fusible material within said membrane so as to form a crust below said membrane.
